(19) United States
(12) Patent Application Publication
(10) Pub. No.: US 2026/0084151 A1
(43) Pub. Date: Mar. 26, 2026

(54) MICROFLUIDIC CARTRIDGE HAVING A VENT CHANNEL AND METHOD OF FILLING A REACTION CHAMBER USING SAME

(71) Applicant: CANON VIRGINIA, INC., Newport News, VA (US)

(72) Inventors: Patrick David Erb, Yorktown, VA (US); Maxwell Pierce Hensley, Williamsburg, VA (US)

(21) Appl. No.: 19/103,355

(22) PCT Filed: Aug. 11, 2023
(86) PCT No.: PCT/US2023/072116

§ 371 Date: Feb. 12, 2025

Related U.S. Application Data
(60) Provisional application No. 63/397,556, filed on Aug. 12, 2022.

(51) Int. Cl. B01L 3/00

(52) U.S. Cl. CPC B01L 3/502738; B01L 2200/0689; B01L 2300/048; B01L 2300/0867; B01L 2400/0638

(57) ABSTRACT

There is provided a valve design for use in a microfluidic cartridge and a method of filling a microfluidic cartridge wherein a reaction chamber can be sealed such that the accidental entrapment of air at the sealing interface is prevented.

### PRIORITY

The present application is a National Phase Filing of International Patent Application No. PCT/US2023/072116 filed Aug. 11, 2023, which claims priority to U.S. Provisional Patent Application Ser. No. 63/397,556 filed Aug. 12, 2022, the disclosure of which is incorporated herein by reference in its entirety.

### FIELD

This application generally relates to the structure of microfluidic devices and in particular, methods of sealing reaction chambers on microfluidic devices.

### BACKGROUND

Standard methods for Polymerase Chain Reaction (PCR) and/or High Resolution Melt (HRM) sample analysis can include introducing one or more samples and the necessary reagents into a channel of a microfluidic device in order to perform the desired test on the samples. Microfluidic devices that can be used for such reactions typically include at least one inlet hole or port, connected by a channel to at least one outlet hole or port. Example devices include those as described in U. S Patent Application Publication No. 2020/0030800. Microfluidic devices may include one or more channel, and may additionally include one or more chambers, including reaction chambers. Microfluidic channel sizes are typically in the range of 10 to 300 μm, the sizes of fluidic connection holes are from 200 to 1500 μm, and the diameters of reagent/waste wells are typically in the range of 2000 to 5000 μm. To enable accurate optical detection and precision flow control, manufacturing tolerances of the process channels are quite stringent, and such chips are typically made of materials with superior optical qualities, such as glass, silica quartz, or high quality polymers.

Proper sealing of a microfluidic chip is essential when performing PCR and other similar reactions in order to prevent the displacement of fluid in reaction chambers. The cyclic heating and cooling process can lead to fluid expansion which can lead to undesired outcomes such as fluid movement without the channel or device, inadvertent mixing of samples or reagents, or expulsion of the fluid from a portion of the microfluidic device, allowing for the growth of trapping of air pockets in the device. Therefore, there is a need for a simple and effective method for sealing a microfluidic device, channel and/or reaction chamber that prevents the accidental entrapment of air at the sealing interface.

### SUMMARY

The present disclosure relates to methods and devices for fluidically sealing a microfluidic cartridge to prevent contamination and avoid trapped air bubbles.

Thus, in one aspect, the present disclosure provides a sealing chamber having one or more inlets, a sealing surface and a moat surrounding the sealing surface. In some embodiments, a helical ramp traverses around the perimeter of the sealing surface from the level of the sealing surface to the level of the moat bottom. The sealing surface can be contacted by a flexible flat seal, or a plug-type seal.

In an additional aspect, the present disclosure provides a microfluidic vent comprising a sealing chamber having one or more inlets, a sealing surface and a moat surrounding the sealing surface. In some embodiments, the vent can include a helical ramp traverses around the perimeter of the sealing surface from the level of the sealing surface to the level of the moat bottom.

In another aspect, the present disclosure provides a microfluidic cartridge comprising one or more sealing chambers, and optionally one or more vent channels.

In a further aspect, the present disclosure provides a method of filling and sealing a microfluidic cartridge having one or more valves comprising a sealing chamber, and one or more vent channels, such that the trapping of air bubbles is prevented.

In one aspect of the present disclosure, there is provided a microfluidic valve comprising a sealing camber and a sealing device. In another aspect, the sealing chamber can comprise at least one fluid inlet, a raised platform protruding from the bottom surface of the sealing chamber; wherein the upper surface of the sealing chamber is a sealing surface and wherein the at least one fluid inlet traverses upwards through the raised platform and opens onto the sealing surface.

In a further aspect, there is provided a moat area surrounding the raised platform and bounded by walls of the sealing chamber. In yet another aspect, there can be a helical ramp circumnavigating the raised platform and extending from the bottom of the sealing chamber to the sealing surface. In one aspect, the sealing device, when depressed, seals against the sealing surface and isolates fluid in the sealing chamber or in the fluid inlet.

In another aspect of the present disclosure, there is provided a microfluidic cartridge comprising a microfluidic valve comprising a sealing camber and a sealing device. The sealing chamber on the microfluidic cartridge can comprise at least one fluid inlet, a raised platform protruding from the bottom surface of the sealing chamber, where the upper surface of the sealing chamber is a sealing surface and where the at least one fluid inlet traverses upwards through the raised platform and opens onto the sealing surface.

In a still further aspect, there is provided a moat area surrounding the raised platform and bounded by walls of the sealing chamber on the microfluidic cartridge. In a yet further aspect, there can be a helical ramp circumnavigating the raised platform and extending from the bottom of the sealing chamber to the sealing surface. In one aspect, the sealing device, when depressed, seals against the sealing surface and isolates fluid in the sealing chamber or in the fluid inlet such that fluid will not leak from the microfluidic cartridge during while a reaction is being performed. In another aspect, the sealing additionally prevents the trapping of air bubbles within the microfluidic cartridge.

In another aspect of the present disclosure, the valves or microfluidic cartridges include a raised platform that does not extend beyond the height of the sealing chamber.

In one aspect, the sealing device for a valve or microfluidic cartridge comprises a thin film lid, elastomer, or a plug which fits within the sealing chamber. In one aspect, the plug has an elastomeric sealing surface. In a further aspect, the sealing device comprises a thin film lid or elastomer which is attached to the microfluidic cartridge above the sealing chamber and is arranged to completely cover and overhang the perimeter of the sealing chamber.

In another aspect, the sealing chamber can additionally comprise a vent inlet, which can be located on the bottom surface of the sealing chamber surrounding the raised platform. In a further aspect, the vent inlet located on the bottom surface of the sealing chamber is located at the bottom of the helical ramp.

In a further aspect the sealing device is configured to seal more than one microfluidic valve concurrently. Further, the sealing device can optionally comprise an adhesive on the surface of the sealing device that contacts the sealing surface.

In one aspect, the valve or microfluidic cartridge can have a vent inlet that is fluidically connected to a vent channel. In a further aspect, the vent channel is configured to allow air contained in the fluid to vent from a vent valve on the vent channel.

In yet a further aspect, the outlet additionally comprises a valve configured to evacuate air to reduce a pressure in a reaction chamber in a state that the inlet valve is closed. In another aspect, the valve is configured such that fluid flows into the moat surrounding the raised platform from the fluid inlet.

In one aspect, the microfluidic cartridge can have one or more reaction chambers are independently selected from the group comprising: an individual channel, one or more wells, one or more parallel branching channels, one or more cascading channels, or one or more serpentine channels.

In another aspect of the present disclosure, there is provided a method of filling a microfluidic cartridge with a sample to avoid air bubbles, comprising the steps of providing a microfluidic cartridge, inserting the microfluidic cartridge into an analysis instrument, sealing the at least one inlet valve, degassing the at least one reaction chamber, sealing the at least one outlet valve, adding a sample to the inlet, such that the sample enters the inlet, the inlet valve, the vent channel and the vent valve, sealing the at least one vent valve, opening the at least one inlet valve, pulling the sample fluid into the at least one reaction chamber, sealing the at least one inlet valve; and performing a reaction on the sample.

In a further aspect, the microfluidic cartridge can comprise at least one microfluidic channel, wherein at a proximal end, there is provided at least one inlet and at least one inlet valve, wherein at least one vent channel and at least one vent valve are fluidically connected to the inlet, wherein at a distal end of the microfluidic channel there is provided at least one outlet and at least one outlet valve; and wherein disposed between the inlet and outlet is at least one reaction chamber.

In one aspect, degassing the at least one reaction chamber comprises applying a vacuum force to the at least one outlet, which outlet is fluidically connected to the reaction chamber. In a further aspect, the sample can be pulled into the at least one reaction chamber by the vacuum created in the at least one reaction chamber during the degassing of the at least one reaction chamber.

These and other embodiments, objects, features, and advantages of the present disclosure will become apparent upon reading the following detailed description of exemplary embodiments of the present disclosure, when taken in conjunction with the appended drawings, and provided claims. It is particularly noted that the features provided herein can be used in any combination or order as appropriate to fulfil the desired fluid movement on a microfluidic cartridge. Further, while the disclosure has been directed to a microfluidic scale, it is also within the scope of this disclosure that the valves, venting channels, and combinations thereof could be used in larger-scale fluidics applications.

### BRIEF DESCRIPTION OF THE DRAWINGS

The accompanying drawings, which are incorporated herein and form part of the specification, illustrate various embodiments, objects, features, and advantages of the present disclosure.

FIG. 1 is a cross-sectional depiction of a sealed channel according to one aspect the present disclosure.

FIG. 2 is a diagram depicting a fluid flow path in a microfluidic cartridge having a plug-type sealing component according to one aspect of the present disclosure.

FIG. 3A-B are diagrams depicting a microfluidic cartridge having a plug-type sealing component when the plug is in the open (FIG. 3A) and closed (FIG. 3B) positions according to one aspect of the present disclosure.

FIG. 4A-4C are diagrams depicting the sealing chamber structure, without the plug type seal component depicted, according to one aspect of the present disclosure. FIG. 4A provides the inlet well and sealing chamber with fluidic connections; FIG. 4B provides the sealing surface and the moat helical ramp structure; and FIG. 4C provides a cross-sectional view of the ramp structure and sealing surface.

FIG. 5 is a diagram that depicts a microfluidic device in according to one aspect of the present disclosure.

FIG. 6 is an exploded diagram of a microfluid cartridge according to one aspect of the present disclosure.

FIG. 7 is a diagram of a microfluidic cartridge having a plug-type sealing component according to one aspect of the present disclosure.

FIG. 8 is an exploded diagram of a microfluidic cartridge having a plug-type sealing component according to one aspect of the present disclosure.

FIG. 9 is a photograph of a laser etched channel with a vent according to one aspect of the present disclosure.

FIG. 10 is a diagram of an exemplary microfluidic cartridge with multiple reaction chambers arranged along microfluidic channels according to one aspect of the present disclosure.

FIG. 11 is an enlarged diagram of an exemplary cascading or branching structure of a reaction chamber along a microfluidic channel according to one aspect of the present disclosure.

FIG. 12 is a workflow for using a microfluidic device according to one aspect of the present disclosure.

FIG. 13A is two images of a microfluidic cartridge taken after 1 PCR cycle and again after 100 PCR cycles. FIG. 13B is a graph depicting the temperature cycling that the microfluidic cartridge was subjected to.

FIG. 14 is photographs of two microfluidic cartridges taken after 1, 15, 40 and 100 PCR cycles.

Throughout the figures, the same reference numerals and characters, unless otherwise stated, are used to denote like features, elements, components or portions of the illustrated embodiments. Moreover, while the subject disclosure will now be described in detail with reference to the figures, it is done so in connection with the illustrative exemplary embodiments. It is intended that changes and modifications can be made to the described exemplary embodiments without departing from the true scope and spirit of the subject disclosure as defined by the appended claims.

### DETAILED DESCRIPTION

The present disclosure has several embodiments and relies on patents, patent applications and other references for details known to those of the art. Therefore, when a patent, patent application, or other reference is cited or repeated herein, it should be understood that it is incorporated by reference in its entirety for all purposes as well as for the proposition that is recited.

The present disclosure provides features that can be integrated in a microfluidic cartridge to allow for accurate and repeatable sealing integrated onto a chip to prevent contamination. Such features will be more fully described here, and include a venting method that allows for a reaction chamber to be evacuated of air prior to filing with a sample, which reduces likelihood of trapped bubbles and nucleation sites.

### Valve Structures

The present invention relies on a valve structure that allows the user to seal an array of channels in a microfluidic cartridge.

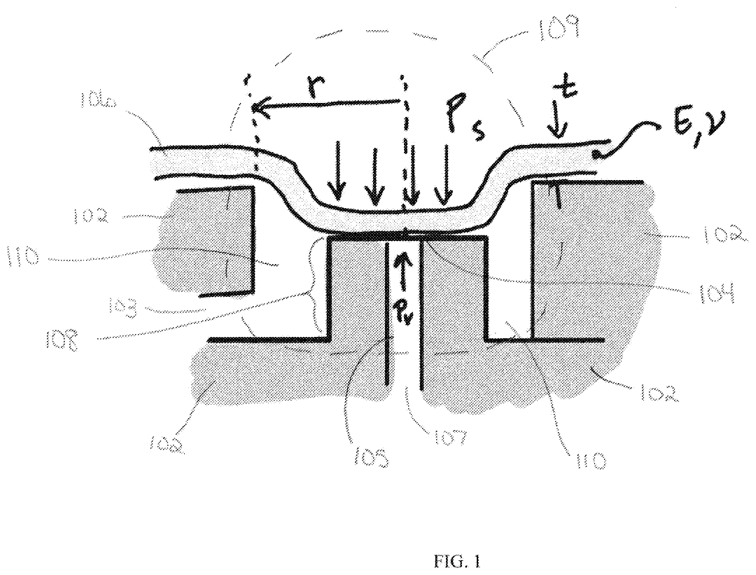

In one embodiment, a valve structure is shown in FIG. 1. Microfluidic cartridge 102 comprises an upper and a lower surface, with microfluidic channel 103 contained within the cartridge 102. Microfluidic channel 103 has therein a sealing chamber that comprises a raised platform or protrusion 108, which contains a valve opening 104 that is fluidically connected to valve channel 105. Raised platform or protrusion 108 is surrounded by moat 110, which is in fluid communication with microfluidic channel 103. When valve opening 104 is open, fluid 107 travels through valve channel 105, through the valve opening 104, and into the microfluidic channel 103. When the valve opening 104 is closed, as depicted in FIG. 1, fluid 107 is still present in valve channel 105, however the fluid is prevented from flowing through the valve opening 104 into microfluidic channel 103 by means of seal 106, which is depressed onto the flat upper surface of raised platform or protrusion 108 and onto valve opening 104 within the raised platform or protrusion 108.

Seal 106 is depressed externally onto the flat upper surface of raised platform or protrusion 108 and onto valve opening 104 within the raised platform or protrusion 108 using a sealing pressure Ps, which causes the valve to close. Sealing pressure Ps must be greater than the pressure at the valve opening or interface 104, which is designated Valve pressure Pv. Valve pressure Pv is dependent on the force with which the fluid 107 is being caused to flow through the valve opening 104.

Seal 106 can be a thin film which is attached or anchored to the top of microfluidic cartridge 102, and extends fully across the valve 109. Seal 106 has a thickness t, an elastic modulus δ, and Poisson's ratio, υ. Together, the elastic modulus δ and Poisson's ratio υ, describe the deformability of the seal which allows it to be depressed to fully cover and close the valve opening 104. One of skill in the art can determine an appropriate elastic modulus δ that would allow the seal to stretch sufficiently in response to the sealing pressure in order to cover and close the opening while still maintaining sufficient elasticity to return to its original position following removal of the sealing pressure. Similarly, one of skill in the art will be able to determine an appropriate Poisson's ratio (the ratio of the change in width per unit width of a material, to the change in its length per unit length, as a result of strain or pressure) of the seal in order to ensure that it will sufficiently deform in response to the sealing pressure to fully close the valve opening 104. The seal 106 may optionally have pressure or temperature activated adhesive on the side of the seal that will contact the valve opening 104 and raised platform 108, to assist in the bond of the seal 106 to the valve opening 104 and raised platform 108, which in combination are referred to as the sealing surface.

In another embodiment, the valve 109 can also work in reverse, such that fluid in microfluidic channel 103 can be prevented from entering valve channel 105.

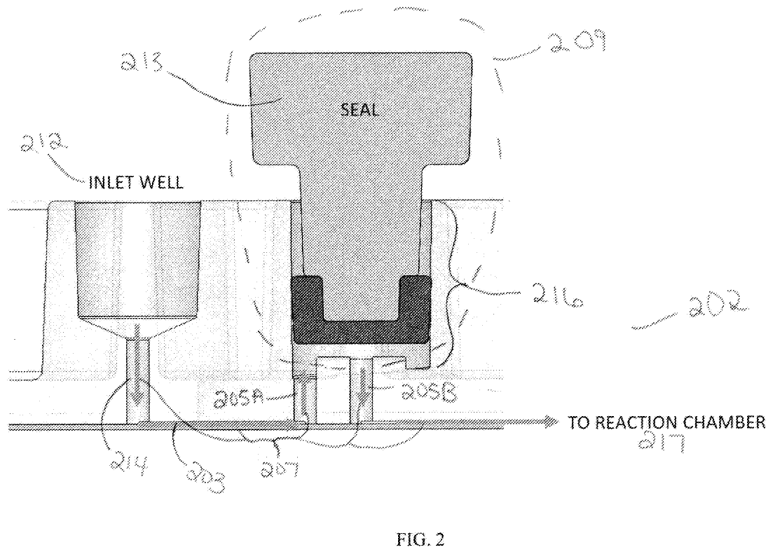

Error! Reference source not found. provides a cross sectional view of another embodiment. Although FIG. 2 includes both an inlet well 212 and a valve 209, the valve 209 can be used with or without an inlet well. Similarly, the valve 109 from FIG. 1 while shown individually, could also be used in combination with an inlet well.

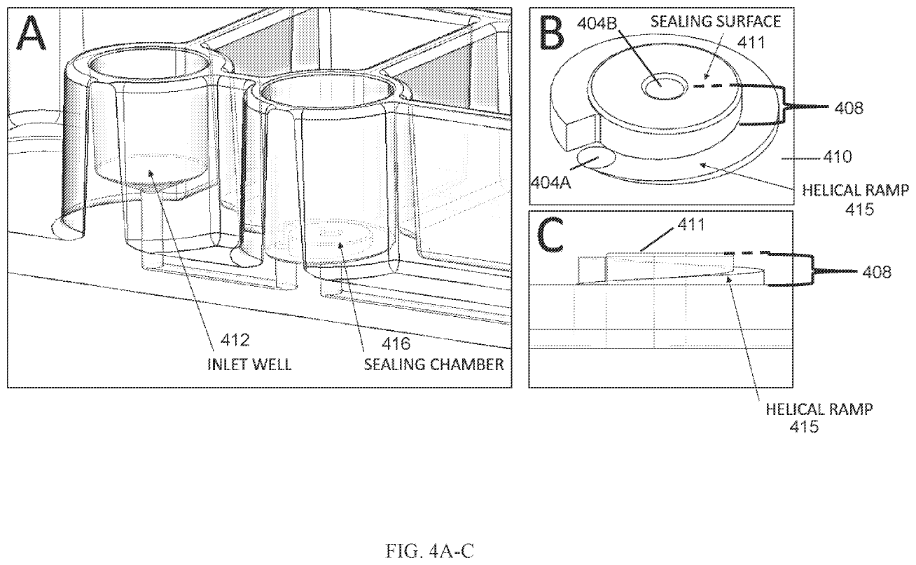

Valve 209 as depicted is similar to valve 109, however, instead of a flat, deformable seal 106, valve 209 is closed by means of a plug 213. Valve 209 is shown within sealing chamber 216, which can have the general form of a well. In FIG. 2, inlet well 212 is fluidically connected via inlet channel 214 and valve channel 205A to the valve 209 in sealing chamber 216. Fluid 207 entering valve 209 does so through valve channel 205A, which causes the fluid 207 to enter from the bottom of the cartridge 202 into the moat structure 210 (not shown in FIG. 2), via opening 404A as shown in FIG. 4B. The fluid flowpath in FIG. 2 is depicted by the arrows; namely, the fluid travels from the inlet well 212 through the sealing chamber 216, around the plug type seal 213 and into the reaction chamber 217. One embodiment of a spatial relationship and fluidic connections between inlet well 412 and sealing chamber 416 is depicted in FIG. 4A. FIG. 4B provides a simplified view of the sealing surface 411, ports 404A and 404B, the moat structure 410 and helical ramp 415. Moat structure 410 is also shown more fully in FIG. 4B, where the moat structure 410 has a helical ramp 415 around the perimeter of the raised platform 408. A cross-sectional view of ramp 415 and raised platform 408 is shown in FIG. 4C, while FIG. 4B additionally depicts valve opening 404B within sealing surface 411. Ramp 415 prevents trapped air in the sealing chamber 416 while also reducing the dead volume during filling. The seal is created by depressing the plug 213 against the sealing surface 411. The sealing chamber configuration shown in FIG. 4A-C as shown does not have a vent channel, but one can be used in conjunction with his configuration.

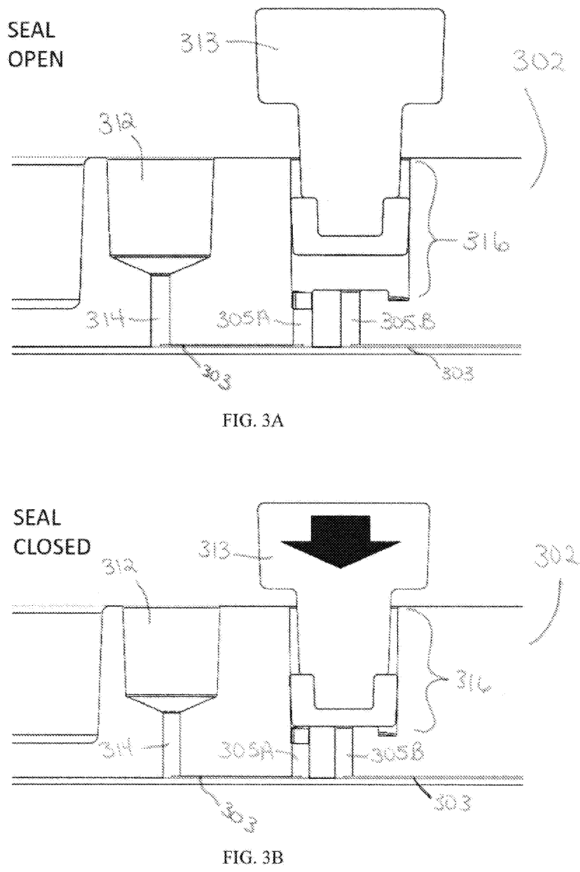

Actuation of the seal as shown in any of FIG. 1-4 can be performed either by a user or an instrument. One or more seals can be actuated at the same time, or multiple seals can be actuated in a specific series to cause fluid to move throughout the microfluidic cartridge. Further, seals can be individual as shown in FIGS. 2 and 3, or multiple seals can be permanently connected together or removably connected together so that actuation can be accomplished for multiple seals with a single action.

Error! Reference source not found. A-B depicts an exemplary plug type seal 313 in the open (FIG. 3A) and closed positions (FIG. 3B). It is noted that certain structures of the valve are obscured by the plug type seal 313, and those will be referred to herein with respect to FIG. 2, as indicated by the reference number beginning with “2”. Sealing chamber 316 is fluidically connected to inlet well 312 via inlet channel 314, microfluidic channel 303 and valve channel 305A. Sealing chamber 316 contains a raised platform surrounded by a moat structure, wherein a helical ramp is around the perimeter of the raised platform, as depicted in FIG. 4B-C. When in the “open position”, plug type seal 313 is in a position above the sealing surface 311 (not depicted), such that the valve opening 304 to valve channel 305B is open. Upon actuation of the valve, the plug type seal 313 is pressed downward into the sealing chamber 316, so that the bottom of the plug type seal 313 makes contact with the sealing surface 311, thereby blocking or “closing” the valve opening 304.

In an another embodiment, sealing chamber 216 and 316 can be filled via valve channel 205B, 305B, such that the fluid enters through the opening 204 on the upper surface of the raised platform 208 and travels down to the surrounding moat 210. In such an embodiment, closing the valve using seal 213, 313 prevents the fluid from travelling between opening 204 and the moat 210.

In a further embodiment, when sealing chamber 216 and 316 are filled via valve channel 205B, 305B, valve channel 205A, 305A can be connected to a vent channel. When connected to a vent channel, the vent channel can be used to remove trapped air from the fluid within the valve or a chamber in order to help prevent the inclusion of air bubbles during fluid movement or during thermal reactions.

### Microfluidic Cartridge Structures

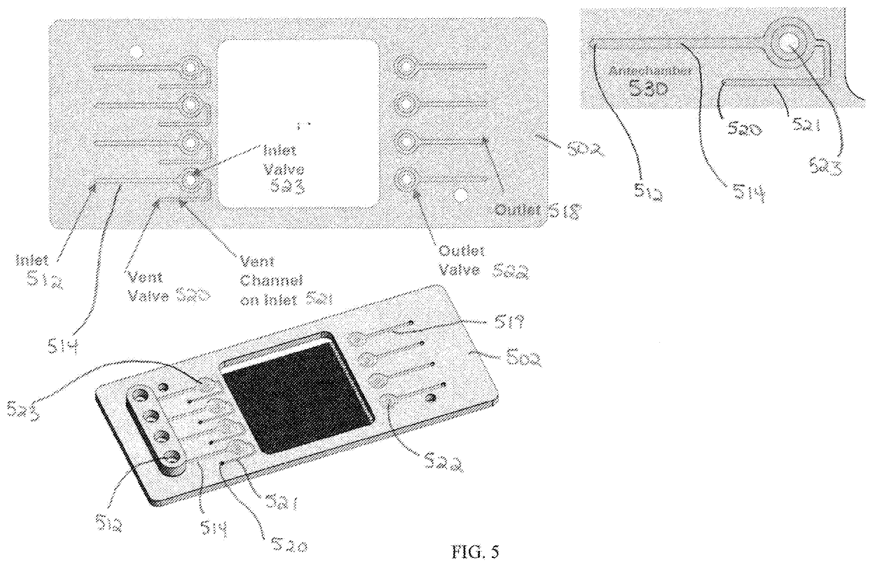

FIG. 5 provides an exemplary microfluidic cartridge 502. Microfluidic cartridge 502 contains inlet 512 through which a sample fluid is provided. Inlet 512 is fluidically connected in series to inlet channel 514, inlet valve 523, vent channel 521 and vent valve 520. When sample fluid is provided to inlet 512, the fluid flows through inlet channel 514 into inlet valve 523. Inlet valve 523 is additionally fluidically connected downstream to at least one reaction chamber (not shown).

Downstream from the inlet valve 512, the at least one reaction chamber is fluidically connected to outlet valve 522, outlet channel 519 and outlet port 518. Outlet 518 can be used to remove sample fluid from at least one reaction chamber. The outlet valve 522 can act to evacuate air from the at least one reaction chamber in order to reduce pressure in that chamber when the inlet valve is closed. In such an embodiment, the pressure in one of the at least one reaction chambers is reduced prior to the sample fluid being provided to the at least one reaction chamber. When taken together, the inlet 512, the inlet channel 514, the inlet valve 523, the vent channel 521 and the vent valve 520 form an antechamber 530 which can be filled with sample prior to that fluid sample being passed on to the at least one reaction chamber. Once the antechamber 530 is filled with the sample, a vacuum can be applied to the at least one reaction chamber via the outlet well. Once a vacuum has been achieved the inlet valve can be opened and the sample in the antechamber 530 is then pulled into the chip without any risk of bubbles being introduced.

The valves found in microfluidic cartridge 502, specifically including, but not limited to, inlet valve 523, comprises the valve structure depicted in FIG. 1. Specifically, the valve comprises a sealing chamber that has a raised platform or protrusion surrounded by a moat area between the perimeter of the raised platform and the perimeter of the sealing chamber. The raised platform contains a valve opening onto the upper surface of the raised platform, which functions as a sealing surface. Fluid can enter the valve via the valve opening. To close the valve, a sealing device can be depressed over the sealing chamber to cover the sealing surface and vent opening. In some embodiments, the sealing chamber can include a vent opening located within the moat and fluidically connected to a vent channel and a vent valve. The vent valve can vent air contained in the sample fluid from within the sealing camber.

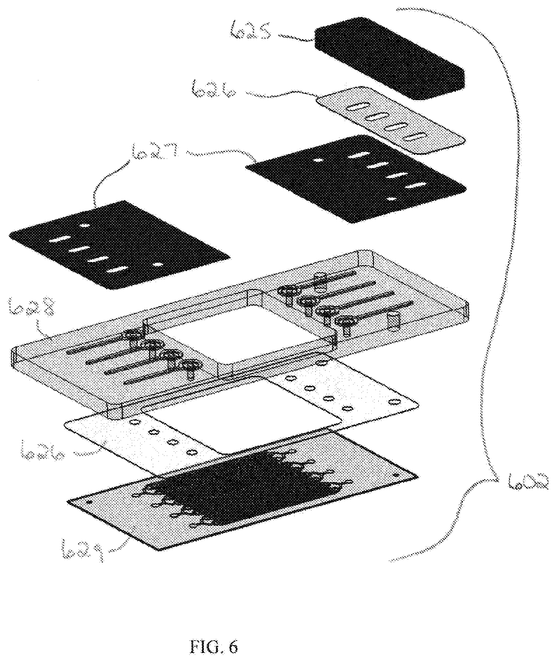

FIG. 6 provides an exemplary exploded view of the microfluidic cartridge 502, 602 from FIG. 5 that depicts individual layered components that can be assembled into the cartridge. From top to bottom, the microfluidic cartridge can be assembled as an inlet well layer 625, which can be attached via adhesive 626 to lid and valve sealing surface 627. Lid and valve sealing surface 627 can be attached to valve manifold layer 628, which is then in turn attached via adhesive 626 to reaction chamber layer 629. Methods of attachment that can be utilized in assembly of microfluidic cartridges include pressure sensitive adhesive (“PSA”) layers, curable liquid adhesive, single sided tape, double sided tape, adhesive transfer tape, curable resins, polymer-based glues, or similar as known to those of skill in the art. The layers can be made from glass or silica quartz, plastic, resin, or other similar materials.

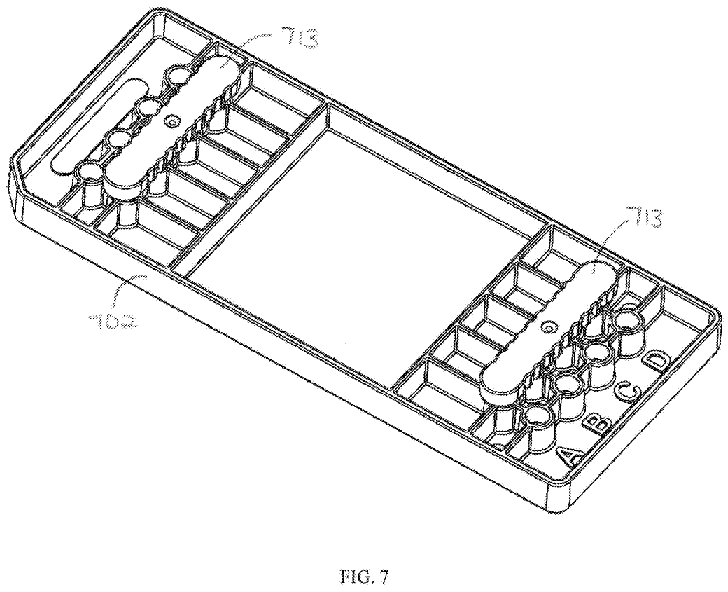

FIG. 7 provides an further embodiment of the microfluidic cartridge 702 wherein the sealing device 706 is not a thin film lid but rather a cylindrical plug. As shown in FIG. 7, in one embodiment, more than one cylindrical plug 706 may be permanently or removably connected together such that they can be used to “close” more than one valve concurrently when depressed into the sealing chamber. The cylindrical plug 706 can optionally have an elastomeric sealing surface or can have an adhesive applied to the surface that will contact the sealing surface.

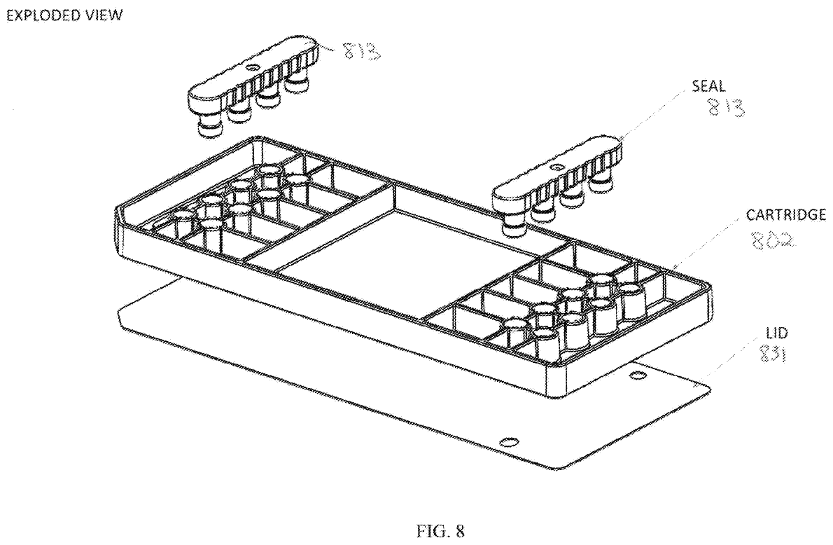

FIG. 8 provides an exploded view of the microfluidic cartridge from FIG. 7. Microfluidic cartridge 802 provided with a plug-type seal 813 that is designed to seal multiple valves at one time. In this embodiment, the plug type seal 813 can be made as a single piece, or multiple plug type seals 813 can be removably or permanently attached together to form single plug type seal 813 that will seal multiple valves. Also depicted in FIG. 8 is a lid 831 which can be permanently or removably attached to the microfluidic cartridge 802.

In one embodiment, microfluidic cartridges in accordance with the preset disclosure can additionally contain one or more valves and or vents as described herein. For instance, each inlet well can be fluidically connected to a vent valve which in turn is fluidically connected to a vent channel. Inlets, outlets, channels, reaction chambers, vents, and valves may be used in combination within a microfluidic cartridge to introduce a sample, add necessary reagents, allow mixing of the sample and reagents, and deliver the necessary sample, mixture or reagents to the reaction chamber(s). Similarly, downstream from reaction chambers, microfluidic channels can be fluidically connected to one or more outlets, waste channels and/or vents.

### Vent Valves

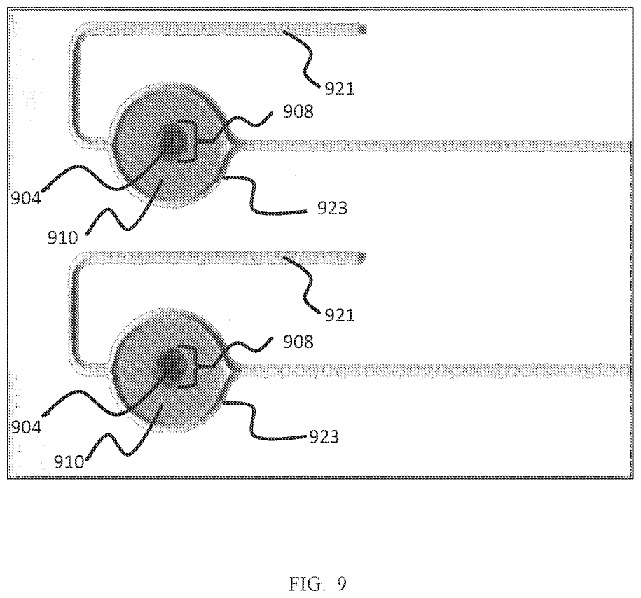

In one embodiment, the valves of the present disclosure can be used to provide a vent channel 921 in fluidic communication with a valve and downstream channel(s). In one embodiment, a vent channel 921 can be fluidically connected to a valve 923 of a microfluidic cartridge, as shown in Error! Reference source not found. Valve 923 contains valve opening 904, which is located within sealing surface 911, which is the uppermost surface of raised platform 908. Raised platform 908 can be surrounded by a moat 910, with a helical ramp 915 between the bottom of moat 910 and the sealing surface 911. FIG. 9 depicts a valve 923 that has been laser etched into the microfluidic cartridge.

### Reaction Chambers

Microfluidic cartridges can contain one or more reaction chambers. Reaction chambers are areas of the microfluidic chip in which a sample any necessary reagents undergo thermal cycling or other processing necessary to achieve the desired reaction. Such reaction chambers can be configured as wells, chambers, or channels.

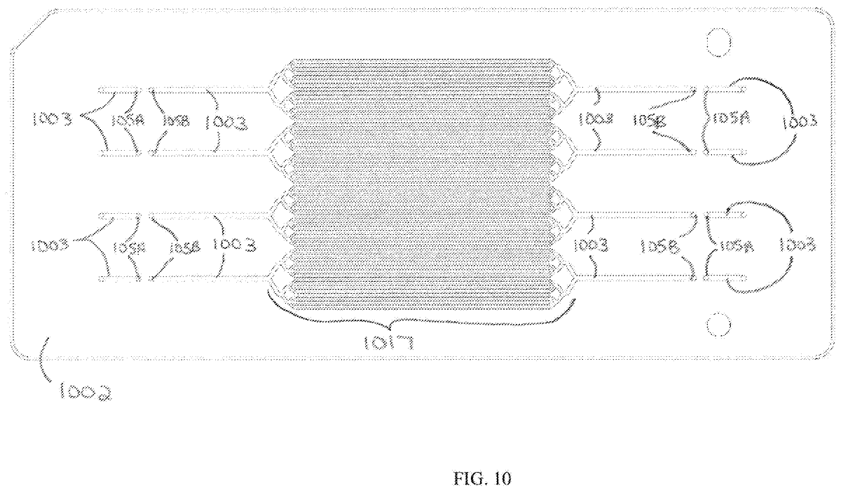

FIG. 10 provides an exemplary bottom view of a reaction chamber according to one embodiment. For instance, FIG. 10 could be viewed as the bottom of microfluidic cartridge 302 shown in FIG. 3. Similarly, FIG. 10 could be the bottom view of FIGS. 4, 7, and 8. For ease of reference, discussion of FIG. 10 will refer to FIG. 3.

As depicted in FIG. 10, the bottom of microfluidic cartridge 1002 shows the bottom of ports 1005B (depicted in FIG. 3 as 305B), and ports 1005A (depicted in FIG. 3 as 305A) which are fluidically connected to one or more of microfluidic channel(s) 1003 (303 in FIG. 3).

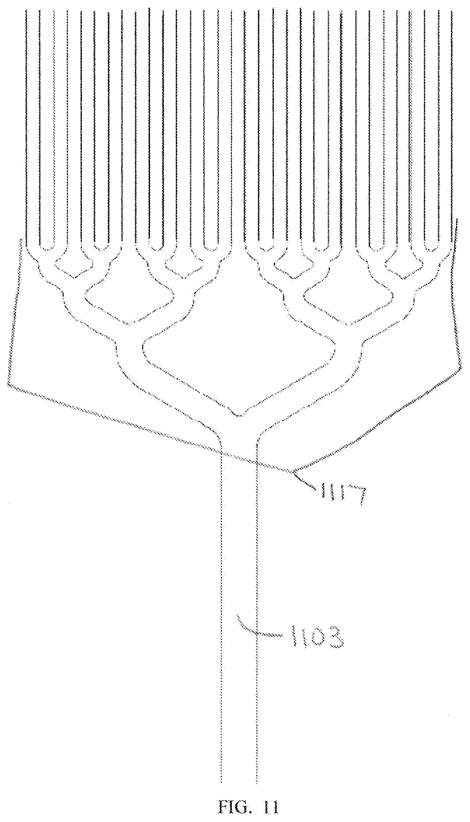

Reaction chambers 1017 can be a single chamber, or reaction chambers 1017 can branch and split into a multitude of parallel, cascading or serpentine sub-channels as depicted in FIG. 10 and shown in more detail in FIG. 11. Although FIG. 10 shows four sample channels with connected reactions chambers in this configuration, the microfluidic cartridge could comprise a single sample channel, or a multiple of sample channels. FIG. 11 depicts microfluidic channel 1103 which branches into a series of smaller parallel channels which serve as reaction chambers 1117. These reaction chamber channels 1117 can then be fluidically connected to the outlet valve 1022 and/or outlet well 1018 of their respective channel(s).

### Fluidics Control using Valves

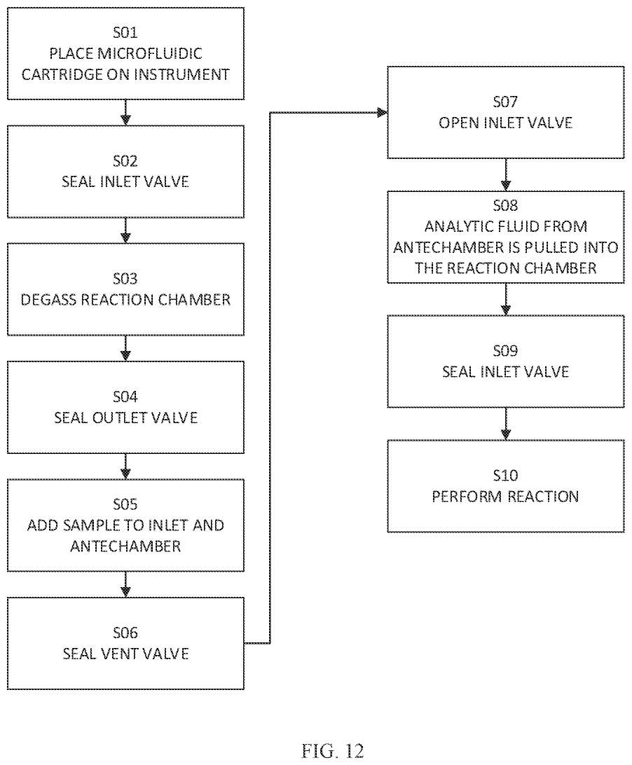

An exemplary workflow to control fluid movement in a microfluidic cartridge having valves according to the present disclosure is provided in Error! Reference source not found. FIG. 12 describes the process of filling a microfluidic cartridge in a manner to reduce the introduction of air bubbles.

In step S01, a microfluidic cartridge containing one or more of the following: inlet valves, outlet valves, reaction chambers, vent valves and antechambers, according to the present disclosure, is installed on to an instrument. The instrument can be, for example, a device for preforming PCR analysis. The device can have a heating and or cooling system, a fluidic system for causing the movement of fluid within the microfluidic cartridge, including for a sample and any required reagents to reach a reaction chamber, an imaging system to capture image(s) of the fluid in the reaction chamber, and an excitation light source for performing fluorescence imaging.

In step S02, the inlet valve(s) on the microfluidic cartridge is sealed by a lid or by a plug. The sealing can be performed by action of a user, or alternatively, a feature of the instrument may be used to seal the inlet valve automatically.

In step S03, the reaction chamber may be degassed from the outlet valve by application of a vacuum to the outlet valve, which is fluidically connected to the reaction chamber. It may not be necessary to effect a complete vacuum on the reaction chamber. By application of the vacuum to the outlet valve, the pressure in the reaction chamber is reduced so that fluid in the antechamber (including the inlet, the inlet channel, the inlet valve, the vent channel and the vent valve) is pulled when the inlet valve is opened in step S07. The degassing can be performed by a user or alternatively, a feature of the instrument may perform degassing automatically.

When the degassing is performed, the air contained in the sample fluid is removed (vented) via the vent valve before the sample fluid is pulled into the reaction chamber. This venting prevents an accidental entrapment of air in the reaction chamber and prevents the growth of trapped air pockets in the reaction chamber when the sample fluid is heated.

In step S04, the outlet valve is sealed to keep the vacuum state in the reaction chamber.

In step S05, a sample fluid is supplied to the inlet and an antechamber within the microfluidic cartridge which includes the inlet, the inlet valve, the vent channel and the vent valve is filled with the sample fluid. Appropriate amounts of fluid will be determined by the configuration of the microfluidic cartridge, with amounts typically being on the order of uL. For instance, an amount of the sample fluid could be, for example, on the order of 5-50 uL, 10-40 uL, 15-25 uL, or about 18 uL, per antechamber. Any air included in the analytic fluid can be vented through the vent valve.

In step S06, the vent valve is sealed by either a user or by a feature of the instrument, the system may seal the vent valve automatically.

In step S07, the inlet valve is opened either a user or by a feature of the instrument, the system may open the inlet valve automatically.

In step S08, once the inlet valve is opened in step S07, the sample fluid in the antechamber is pulled into the reaction chamber due to the reduced pressure in the reaction chamber, caused by the vacuum applied in step S03.

In step S09, the inlet valve is sealed by either a user or by a feature of the instrument, the system may seal the inlet valve automatically.

In step S10, the instrument is then ready to perform analysis of the sample and the instrument can carry out the standard steps to perform the desired analysis.

The present disclosure relates to the use of microfluidic cartridges for reactions, including those involving thermal cycling. Therefore, although the description and figures herein primarily relate to the valve structures and methods of controlling fluid, it is intended that the disclosed device and method can be integrated into or used with a thermal cycling device, system or method. For example, the structures and methods of the present disclosure can be utilized with or incorporated into known thermal cycling devices, systems or methods, including, for instance, those described in any of US20200232020, WO2020154407, U.S. Pat. Nos.10,226,772, 9,919,314, 9,829,389, 9,823,135, 9,554,422, and, 9,542,526 the contents of which are hereby incorporated herein in their entirety.

### EXAMPLE

Polymer microfluidic cartridges were filled with a constituent solution comprised of water, a synthetic DNA target having a known melting temperature, and LC Green binding dye (BioFire) before being subjected to up to 100 thermal cycles during which temperatures were varied between 55-90° C. in a PCR reaction. The constituent solution fluoresced while the thermal cycling held at an annealing temperature. This allowed visualization of proper sealing of the cartridges, and demonstrated that the reaction was thermal cycling properly.

The cartridges were imaged after select cycles to determine the robustness of the seal and the success of the valve system and seal in preventing air bubbles.

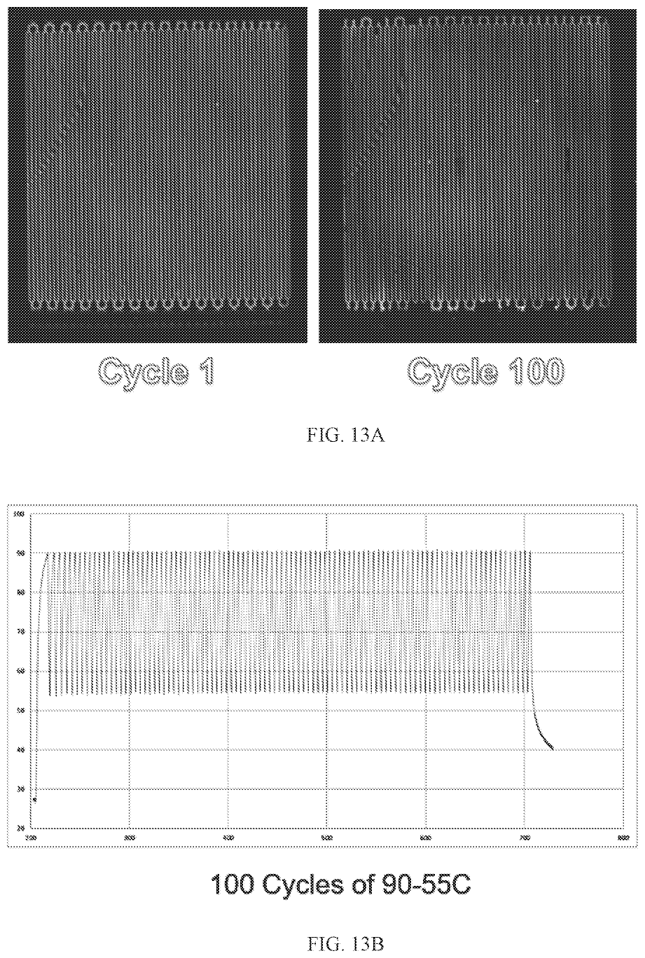

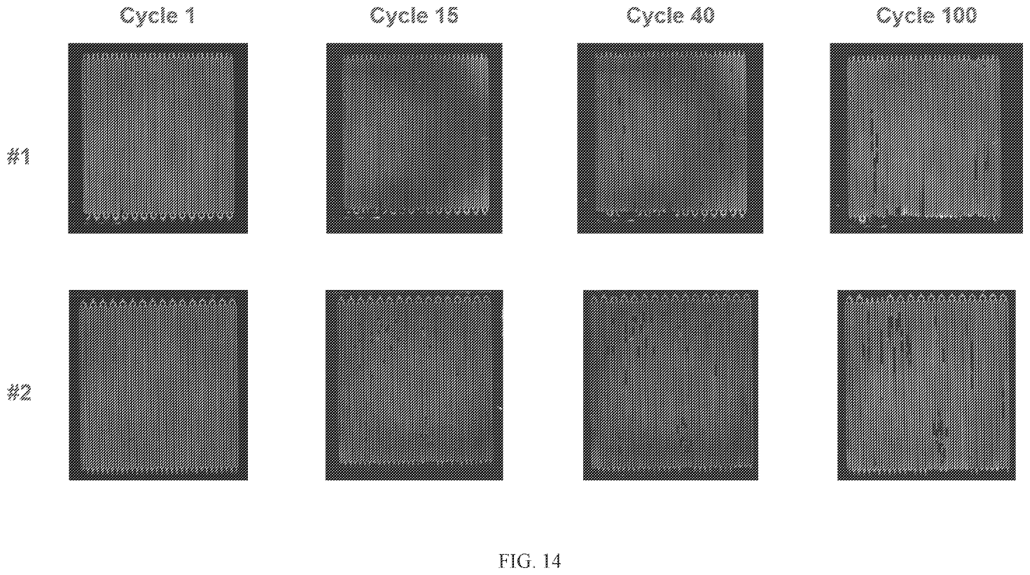

Results are shown in Error! Reference source not found. and Error! Reference source not found. FIG. 14 includes photos from two separate tests, labelled “#1” and “#2”. It is noted that the 100 cycles that were tested are significantly greater than the typical 35-40 cycles of an actual PCR. Thus, 100 cycles was sufficient to test the cartridges under extreme conditions. The temperature profile for the 100 cycle is shown in FIG. 13B. As shown in the images, for all cases there were no leaks present, demonstrating that the seal was robust and held through the 100 cycles. A small number of bubbles were found, as shown in FIG. 14, however these were due to nucleation sites after many cycles, and they remained stationary and grew slowly due to gas exchange between the fluid and the trapped air.

These results were a large improvement over previously known sealing methods, where similar tests demonstrated a great deal of fluid motion and the trapped bubbles grew quickly.

### DEFINITIONS

In referring to the description, specific details are set forth in order to provide a thorough understanding of the examples disclosed. In other instances, well-known methods, procedures, components and circuits have not been described in detail as not to unnecessarily lengthen the present disclosure.

It should be understood that if an element or part is referred herein as being “on”, “against”, “connected to”, or “coupled to” another element or part, then it can be directly on, against, connected or coupled to the other element or part, or intervening elements or parts may be present. In contrast, if an element is referred to as being “directly on”, “directly connected to”, or “directly coupled to” another element or part, then there are no intervening elements or parts present. When used, term “and/or”, includes any and all combinations of one or more of the associated listed items, if so provided.

Spatially relative terms, such as “under” “beneath”, “below”, “lower”, “above”, “upper”, “proximal”, “distal”, and the like, may be used herein for ease of description to describe one element or feature's relationship to another element(s) or feature(s) as illustrated in the various figures. It should be understood, however, that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, a relative spatial term such as “below” can encompass both an orientation of above and below. The device may be otherwise oriented (rotated 90 degrees or at other orientations) and the spatially relative descriptors used herein are to be interpreted accordingly. Similarly, the relative spatial terms “proximal” and “distal” may also be interchangeable, where applicable.

The term “about,” as used herein means, for example, within 10%, within 5%, or less. In some embodiments, the term “about” may mean within measurement error.

The terms first, second, third, etc. may be used herein to describe various elements, components, regions, parts and/or sections. It should be understood that these elements, components, regions, parts and/or sections should not be limited by these terms. These terms have been used only to distinguish one element, component, region, part, or section from another region, part, or section. Thus, a first element, component, region, part, or section discussed below could be termed a second element, component, region, part, or section without departing from the teachings herein.

The terminology used herein is for the purpose of describing particular embodiments only and is not intended to be limiting. The use of the terms “a” and “an” and “the” and similar referents in the context of describing the disclosure (especially in the context of the following claims) are to be construed to cover both the singular and the plural, unless otherwise indicated herein or clearly contradicted by context. The terms “comprising,” “having,” “includes”, “including,” and “containing” are to be construed as open-ended terms (i.e., meaning “including, but not limited to,”) unless otherwise noted. Specifically, these terms, when used in the present specification, specify the presence of stated features, integers, steps, operations, elements, and/or components, but do not preclude the presence or addition of one or more other features, integers, steps, operations, elements, components, and/or groups thereof not explicitly stated. Recitation of ranges of values herein are merely intended to serve as a shorthand method of referring individually to each separate value falling within the range, unless otherwise indicated herein, and each separate value is incorporated into the specification as if it were individually recited herein. For example, if the range 10-15 is disclosed, then 11, 12, 13, and 14 are also disclosed. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

It will be appreciated that the methods and compositions of the instant disclosure can be incorporated in the form of a variety of embodiments, only a few of which are disclosed herein. Variations of those embodiments may become apparent to those of ordinary skill in the art upon reading the foregoing description. The inventors expect skilled artisans to employ such variations as appropriate, and the inventors intend for the disclosure to be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

1. A microfluidic valve comprising:
a sealing chamber comprising:
at least one fluid inlet;
a raised platform protruding from the bottom surface of the sealing chamber; wherein the upper surface of the sealing chamber is a sealing surface, wherein the at least one fluid inlet traverses upwards through the raised platform and opens onto the sealing surface;
a moat area surrounding the raised platform and bounded by walls of the sealing chamber;
a helical ramp circumnavigating the raised platform and extending from the bottom of the sealing chamber to the sealing surface; and
a sealing device, that when depressed, seals against the sealing surface and isolates fluid in the sealing chamber or in the fluid inlet.

2. A microfluidic cartridge comprising:
at least one sample inlet having connected thereto at least one sample channel(s);
wherein each inlet channel comprises at least one valve comprising:
a sealing chamber comprising:
at least one fluid inlet;
a raised platform protruding from the bottom surface of the sealing chamber; wherein the upper surface of the sealing chamber is a sealing surface, wherein the at least one fluid inlet traverses upwards through the raised platform and opens onto the sealing surface;
a moat area surrounding the raised platform and bounded by walls of the sealing chamber;
a helical ramp circumnavigating the raised platform and extending from the bottom of the sealing chamber to the sealing surface; and
a sealing device, that when depressed, seals against the sealing surface and isolates fluid in the sealing chamber or in the fluid inlet;
at least one reaction chamber fluidically connected to each sample channel; and, an outlet port.

3. The microfluidic valve of claim 2, wherein the raised platform does not extend beyond the height of the sealing chamber.

4. The microfluidic valve of claim 2, wherein the sealing device comprises a thin film lid, elastomer, or a plug which fits within the sealing chamber.

5. The microfluidic valve of claim 4, wherein the sealing device is a plug, and wherein the plug has an elastomeric sealing surface.

6. The microfluidic valve of claim 2, wherein the sealing device comprises a thin film lid or elastomer which is attached to the microfluidic cartridge above the sealing chamber and is arranged to completely cover and overhang the perimeter of the sealing chamber.

7. The microfluidic valve of claim 2, wherein the sealing chamber additionally comprises a vent inlet.

8. The microfluidic valve of claim 7, wherein the vent inlet is located on the bottom surface of the sealing chamber surrounding the raised platform.

9. The microfluidic valve of claim 8, wherein the vent inlet located on the bottom surface of the sealing chamber is located at the bottom of the helical ramp.

10. The microfluidic valve of claim 2, wherein the sealing device is configured to seal more than one microfluidic valve concurrently.

11. The microfluidic valve of claim 2, wherein the sealing device comprises an adhesive on the surface of the sealing device that contacts the sealing surface.

12. The microfluidic valve of claim 7, wherein the vent inlet is fluidically connected to a vent channel.

13. The microfluidic valve of claim 12, wherein the vent channel is configured to allow air contained in the fluid to vent from a vent valve on the vent channel.

14. The microfluidic cartridge of claim 2, wherein the outlet additionally comprises a valve configured to evacuate air to reduce a pressure in a reaction chamber in a state that the inlet channel valve is closed.

15. The microfluidic cartridge of claim 2 wherein the one or more reaction chambers are independently selected from the group comprising: an individual channel, one or more wells, one or more parallel branching channels, one or more cascading channels, or one or more serpentine channels.

16. The microfluidic valve of claim 2, wherein the valve is configured such that fluid flows into the moat surrounding the raised platform from the fluid inlet.

17. A method of filling a microfluidic cartridge with a sample to avoid air bubbles, comprising the steps of:
providing a microfluidic cartridge have at least one microfluidic channel, wherein at a proximal end, there is provided at least one inlet and at least one inlet valve, wherein at least one vent channel and at least one vent valve are fluidically connected to the inlet, wherein at a distal end of the microfluidic channel there is provided at least one outlet and at least one outlet valve;
and wherein disposed between the inlet and outlet is at least one reaction chamber;
inserting the microfluidic cartridge into an analysis instrument;
sealing the at least one inlet valve;
degassing the at least one reaction chamber;
sealing the at least one outlet valve;
adding a sample to the inlet, such that the sample enters the inlet, the inlet valve, the vent channel and the vent valve;
sealing the at least one vent valve;
opening the at least one inlet valve;
pulling the sample fluid into the at least one reaction chamber;
sealing the at least one inlet valve; and
performing a reaction on the sample.

18. The method of claim 17, wherein degassing the at least one reaction chamber comprises applying a vacuum force to the at least one outlet, which outlet is fluidically connected to the reaction chamber.

19. The method of claim 18, wherein the sample is pulled into the at least one reaction chamber by the vacuum created in the at least one reaction chamber during the degassing of the at least one reaction chamber.
